(19) United States
(12) Patent Application Publication
(10) Pub. No.: US 2006/0209456 A1
(43) Pub. Date: Sep. 21, 2006

(54) Disk drive apparatus

(76) Inventors: Debashisu Bisuwasu, Shiki-shi (JP); Tomonao Takamatsu, Tokyo (JP); Katsumi Hisano, Matsudo-shi (JP); Hideo Iwasaki, Kawasaki-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/235,164

(22) Filed: Sep. 27, 2005

(30) Foreign Application Priority Data
Mar. 18, 2005 (JP) 2005-079583

(51) Int. Cl. G11B 5/55

(52) U.S. Cl. 360/97.02; 360/266

(57) ABSTRACT

In a disc drive apparatus, a magnetic disc is housed in a casing and rotated by a motor mechanism. A magnetic head for recording information in a disc surface region and for reproducing the recorded information is supported by a carriage arm such that the magnetic head is swingable. Formed on that side of the carriage arm which faces the magnetic disc is a guide portion for guiding the air stream generated on the disc surface such that the air stream is allowed to flow in the longitudinal direction of the carriage arm.

### CROSS-REFERENCE TO RELATED APPLICATIONS

This application is based upon and claims the benefit of priority from prior Japanese Patent Application No. 2005-079583, filed Mar. 18, 2005, the entire contents of which are incorporated herein by reference.

### BACKGROUND OF THE INVENTION

1. Field of the Invention

The present invention relates to a disc drive apparatus, particularly, to an improvement of a disc drive apparatus, e.g., improvement in the carriage mechanism of the disc drive apparatus.

2. Description of the Related Art

With the rapid progress that has been achieved in recent years in the information processing technology, vigorous research is being conducted in an attempt to improve, for example, the disc drive apparatus such as the HDD apparatus (hard disc drive apparatus). Specifically, it has become more and more important to improve the recording density of a recording medium and the recording speed. In this connection, it is very important to improve the accuracy in the positioning of a recording head for recording information in the recording medium and for reproducing the recorded information. However, since the magnetic disc supporting or including the recording medium is rotated at a high speed in a small space within the disc drive apparatus, the maximum air flow rate within the disc drive apparatus is increased to exceed, for example, scores of meters per second regardless of the high technical level that has been reached nowadays. As a result, the accuracy in the head positioning is greatly affected by the turbulence of the air flow, which is called wind turbulence, within the disc drive apparatus. Nowadays, the problem is avoided in a fashion of trial and error by changing the shapes of various parts of the disk drive apparatus. For further improving the recording rate and the recording density of the recording medium, it is necessary to improve the positioning accuracy of the magnetic head by suppressing the wind turbulence.

A measure for improving the positioning accuracy of the magnetic head is disclosed in, for example, Japanese Patent Disclosure (Kokai) No. 2004-185666. It is disclosed that a circular flow rectifying plate is arranged within a casing, the plate being arrange substantially parallel to the magnetic disc used as a recording medium, so as to prevent the fluttering of the magnetic disc, which is called disc flutter, thereby improving the positioning accuracy of the magnetic head.

Also, it is disclosed in Japanese Patent Disclosure No. 2004-171674 that the turbulence of the air stream formed along the disc surface is suppressed by using a flow rectifying plate that is made integral with a ramp member.

However, where a flow rectifying plate is arranged within the disc drive apparatus as in Japanese Patent Disclosure No. 2004-185666 referred to above, it is necessary to arrange the flow rectifying plate as an additional part of the apparatus. The increase in the number of parts of the apparatus leads to an increase in the manufacturing cost of the disc drive apparatus.

When it comes to the construction employing the flow rectifying plate as in the conventional disc drive apparatus exemplified above, it has been clarified that the carriage mechanism is vibrated by the shearing moment generated between the stationary carriage arm and the rotating magnetic disc. In the measure disclosed in Japanese Patent Disclosure No. 2004-171674 referred to above, it is difficult to remove the influence of the vibration of the carriage mechanism.

### BRIEF SUMMARY OF THE INVENTION

An object of the present invention is to provide a disc drive apparatus that permits suppressing the vibration of the carriage mechanism caused by the shearing moment generated between the magnetic disc and the carriage arm so as to improve the positioning accuracy of the magnetic head.

According to a first aspect of the present invention, there is provided a disc drive apparatus, comprising:

a casing;

a magnetic disc housed in the casing and including a disc surface region configured to record information;

a motor rotating the disc;

a magnetic head configured to record information in the disc surface region and reproduce the recorded information;

a suspension that supports the head;

a carriage arm supporting the suspension; and

a carriage mechanism having the carriage arm mounted thereto and serving to swing the head toward an inner region of the disc surface, the carriage arm includes a guide groove arranged to face the disc surface in the longitudinal direction of the carriage arm.

Further, according to a second aspect of the present invention, there is provided a disc drive apparatus, comprising:

a casing;

a magnetic disc housed in the casing and including a disc surface region configured to record information;

a motor rotating the disc;

a magnetic head configured to record information in the disc surface region and reproduce the recorded information;

a suspension supporting the head;

a carriage arm supporting the suspension; and

a carriage mechanism having the carriage arm mounted thereto and serving to swing the head toward an inner region of the disc surface, the carriage arm having a surface region facing the disc surface and a guide wall formed on the surface, the guide wall partially removed at the side of the rotary shaft and the side of supporting the suspension.

### BRIEF DESCRIPTION OF THE SEVERAL VIEWS OF THE DRAWING

FIG. 1 is a plan view schematically showing the inner construction of an HDD apparatus according to an embodiment of the present invention;

FIG. 2 is a plan view schematically showing the construction of the carriage arm included in the HDD apparatus shown in FIG. 1;

FIG. 3 is a plan view also showing schematically the construction of the carriage arm included in the HDD apparatus shown in FIG. 1;

FIGS. 4A, 4B and 4C are partial oblique views exemplifying various shapes of the carriage arms shown in FIGS. 2 and 3; and

FIGS. 5A to 5F are cross sectional views exemplifying various shapes of the carriage arms including those shown in FIGS. 2 and 3.

### DETAILED DESCRIPTION OF THE INVENTION

A disc drive apparatus according to one embodiment of the present invention will now be described with reference to the accompanying drawings.

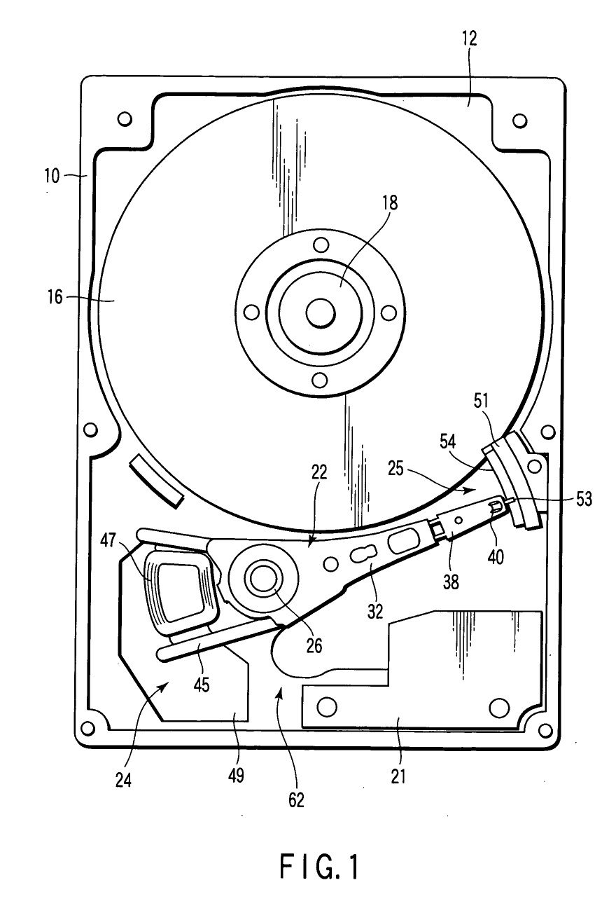

FIG. 1 schematically shows the construction of an HDD apparatus (hard disc drive apparatus) according to one embodiment of the present invention. The following description is on the basis that the open portion of a rectangular box-shaped base 12 of the HDD apparatus, which is shown in FIG. 1, constitutes the upper portion of the apparatus. In other words, the expressions of upper, lower, right, left, front, rear, etc., which are used in the following description, are on the basis given above, though the actual directions are changed depending on the direction in which the HDD apparatus is disposed. For example, if the HDD apparatus under the state shown in FIG. 1 is turned upside down, the right edge on the paper constitutes the left edge, or the upper edge on the paper constitutes the lower edge.

The HDD apparatus shown in FIG. 1 comprises a drive casing 10 including the rectangular box-shaped base 12 referred to above and a top cover (not shown). The base 12 includes a substantially rectangular bottom wall and side walls erected along the four sides of the bottom wall so as to allow the base 12 to have an open upper surface. Also, the top cover is mounted to the side walls of the base 12 by using a plurality of screws so as to close the open upper surface of the base 12. Incidentally, FIG. 1 shows the state that the top cover is removed from the upper open portion of the base 12 so as to make visible the inner construction of the HDD apparatus.

Arranged within the casing 10 are a spindle motor 18 mounted to the bottom wall of the base 12 and a magnetic disc 16 supported and rotated by the spindle motor 18 and used as a recording medium. In many cases, the HDD apparatus is manufactured on the basis that the outer size is determined in accordance with standards. In general, one to five magnetic discs 16 are arranged in the HDD apparatus. The following description is directed to an example of the HDD apparatus having two magnetic discs 16 arranged therein.

Arranged within the casing 10 are a single magnetic head 40 or a plurality of magnetic heads 40 for recording information in the magnetic disc 16 and for reproducing the recorded information, a carriage assembly 22 for supporting the magnetic head 40 such that the magnetic head 40 is movable relative to the magnetic disc 16, a voice coil motor (VCM) 24 for swinging the carriage assembly 22 so as to determine the position of the carriage assembly 22, a ramp load mechanism 25 for holding the magnetic head 40 at a rest position away from the magnetic disc 16 when the magnetic head 40 is moved away from the magnetic disc 16, and a substrate unit 21 including, for example, a preamplifier.

Also, the spindle motor 18, the VCM 24, and a printed circuit board (not shown) for controlling the operation of the magnetic head 40 are mounted to the bottom wall of the base 12 via the substrate unit 21 by using screws.

As shown in FIG. 1, the carriage assembly 22 (carriage mechanism) comprises a bearing section (rotary shaft) 26 fixed to the bottom wall of the base 12 and a single carriage arm 32 or a plurality of carriage arms 32 extending from the bearing section 26. These carriage arms 32 are positioned parallel to the surface of the magnetic disc 16. Also, these carriage arms 32 are positioned a prescribed distance apart from each other. In the case of using a plurality of carriage arms 32, these carriage arms 32 are extended in the same direction from the bearing section 26. The carriage assembly 22 also includes a slender plate-like suspension 38 that can be elastically deformed. The suspension 38 is formed of a leaf spring. The proximal end of the suspension 38 is fixed to the tip of the carriage arm 32 by the spot welding or bonding so as to allow the suspension 38 to extend outward from the carriage arm 32. Incidentally, it is possible for the suspension 38 to be formed integral with the corresponding carriage arm 32.

The magnetic head 40 is mounted to the distal end of the suspension 38. The magnetic head 40 includes a substantially rectangular slider and an MR (magnetoresistance) head for recording-reproducing information. The MR head is formed in the slider, and the magnetic head 40 is fixed to a gimbal section formed at the distal end of the suspension 38. In the case of using four suspensions 38 each having the magnetic head 40 mounted thereto, two magnetic heads 40 are positioned to face each other in a manner to have one of the magnetic discs 16 sandwiched therebetween, and the remaining two magnetic heads 40 are positioned to face each other in a manner to have the other magnetic disc 16 sandwiched therebetween.

On the other hand, the carriage assembly 22 includes a support frame 45 extending from the bearing section 26 in the direction opposite to the extending direction of the carriage arm 32, and a voice coil 47 constituting a part of the VCM 24 is supported by the support frame 45. The support frame 45, which is made of a synthetic resin, is formed integral with the outer circumferential region of the voice coil 47. The voice coil 47 is positioned between a pair of yokes 49 fixed to the base 12. These yokes 49 and a magnet (not shown) fixed to one of these yokes 49 collectively form the VCM 24. If an electric power is supplied to the voice coil 47, the carriage assembly 22 is swung about the bearing section 26 so as to cause the magnetic head 40 to be moved to a desired position in an inner region of the magnetic disc 16, thereby determining the position of the magnetic head 40.

The ramp load mechanism 25 includes a ramp 51, which is mounted to the bottom wall of the base 12 and arranged outside the magnetic disc 16, and a tab 53 extending outward from the distal end of the suspension 38. When the carriage assembly 22 is swung so as to cause the magnetic head 40 to be moved to a rest position outside the magnetic disc 16, the tab 53 is engaged with a ramp surface 54 of the ramp 51 and, then, the magnetic head 40 is pulled upward by the inclination of the ramp surface 54 so as to unload the magnetic head 40.

As shown in FIG. 1, the magnetic disc 16 has a diameter of, for example, 65 mm (2.5 inches). An inner hole (not shown) is formed in the central portion of the magnetic disc 16, and a magnetic recording layer is formed on each of the upper and lower surfaces of the magnetic disc 16. The spindle motor 18 includes a hub (not shown) functioning as a rotor. Two magnetic discs 16 are coaxially engaged with the hub so as to be stacked one upon the other a prescribed distance apart from each other in the axial direction of the hub. Also, the magnetic disc 16 is rotated at a prescribed speed by the spindle motor 18 together with the hub.

If the disc drive apparatus shown in FIG. 1 is operated, the spindle motor 18 is urged so as to rotate the magnetic disc 16, and the VCM 24 is operated so as to swing the carriage arm 32 about the bearing section 26. As a result, the magnetic head 40 under the unloaded state, which is in the rest position on the ramp 51, is moved substantially in the radial direction of the magnetic disc 16 so as to cause the magnetic head 40 to be positioned in an inner region on the magnetic disc 16. The magnetic head 40 is moved along the disc surface so as to reach a prescribed position above the disc surface, i.e., the position of the magnetic head 40 is controlled, so as to record information on the recording surface of the magnetic disc 16 or to reproduce the recorded information. As described above, the magnetic head 40 is positioned on the magnetic disc 16. Incidentally, the expression “on the magnetic disc 16” denotes that the magnetic head 40 is positioned in a point right above the upper surface of the magnetic disc 16 or a point right below the lower surface of the magnetic disc 16.

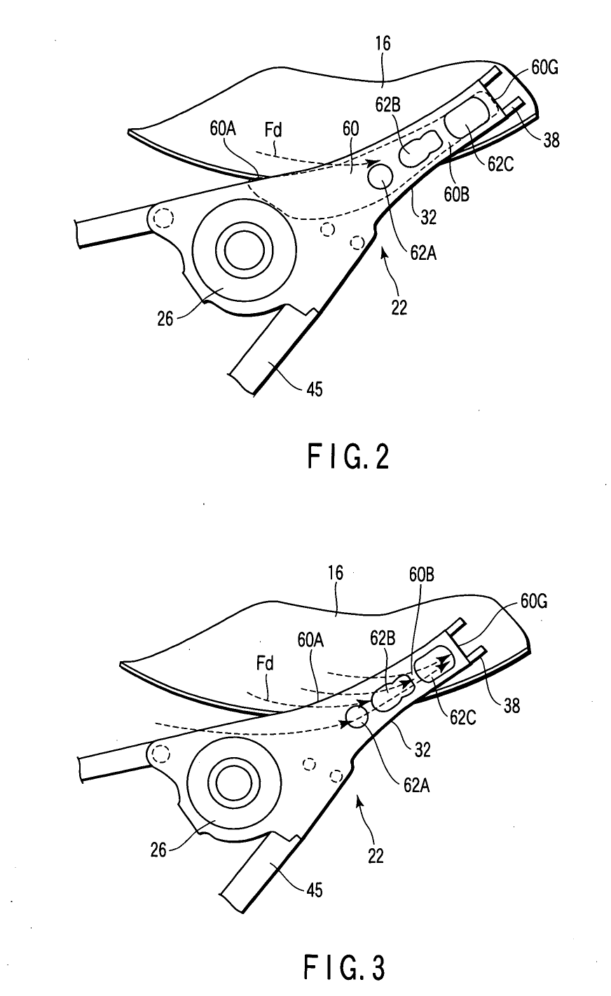

In accordance with rotation of the magnetic disc 16, the air layer on the surface of the magnetic disc 16 forms an air stream flowing along the surface of the disc 16. The rotation of the magnetic disc 16 causes a centrifugal force to be imparted to the air stream, with the result that the air stream flows toward the outer circumferential region of the magnetic disc 16. It follows that the carriage arm 32 is swung toward an inner region of the magnetic disc 16 against the air stream flowing toward the outer circumferential region of the magnetic disc 16. Naturally, the movement of the carriage arm 32 toward the inner region of the magnetic disc 16 is affected by the air stream layer generated on the surface of the magnetic disc 16. It should be noted that the carriage arm 32 is vibrated, if the turbulence is vigorously generated in the air stream flowing toward the carriage arm 32 when the carriage arm 32 is being swung toward the inner region of the magnetic disc 16. The carriage arm 32 is also vibrated similarly, if the air stream layer generated on the magnetic disc 16 is greatly disturbed when the carriage arm 32 is being swung along the surface of the magnetic disc 16. In the disc drive apparatus of the present invention, the air stream flowing though the clearance between the carriage arm 32 and the magnetic disc 16 is optionally guided so as to suppress the turbulence of the air stream (wind turbulence) around the carriage assembly 22, as shown in FIGS. 2 and 3.

Each of FIGS. 2 and 3 shows in a magnified fashion the carriage assembly 22 shown in FIG. 1. FIGS. 2 and 3 are intended to show clearly the construction of the carriage assembly 22 and, thus, the suspension 38 and the voice coil 47 of the VCM 24 supported by the support frame 45 are omitted so as to show emphatically the bearing section 26 and the carriage arm 32 extending from the bearing section 26.

A groove 60 is formed in the carriage arm 32, as denoted by an oblique line. The groove 60 serves to guide the air stream around the carriage assembly 22 such that the air stream flows partly in the longitudinal direction of the carriage arm 32 as denoted by arrows Fd in FIGS. 2 and 3. Naturally, the longitudinal direction of the carriage arm 32 denotes the direction in which the carriage arm 32 extends. Where the carriage arm 32 is curved, the longitudinal direction noted above denotes the direction in which the curved carriage arm extends. In other words, where the carriage arm 32 is curved, the longitudinal direction noted above is also curved.

The guide groove 60 is formed on the back surface in the case of the carriage arm 32 in the uppermost position, and is formed on the front surface in the case of the carriage arm 32 in the lowermost position. When it comes to the carriage arm 32 interposed between the uppermost carriage arm and the lowermost carriage arm, the guide groove 60 is formed on each of the upper and lower surfaces of the carriage arm 32. In other words, the guide groove 60 is formed on that surface of the carriage arm 32 which is positioned to face the magnetic disc.

The guide groove 60 includes an introducing section 60A for introducing the air stream flowing in the transverse direction of the carriage arm 32 into the guide groove 60, a guide section 60B for guiding the air stream within the guide groove 60, and an outlet section 60G for allowing the guided air stream to flow toward the distal end of the carriage arm 32. The introducing section 60A is positioned close and connected to the bearing section 26 and, thus, is mounted to the proximal end section of the carriage arm 32 to which is imparted a relatively sufficient rigidity. Also, the introducing section 60A is formed in the carriage arm 32 on the side of the center of rotation of the magnetic disc 16, i.e., on the side of the spindle motor 18. The guide section 60B extends in the longitudinal direction of the carriage arm 32. Further, the outlet section 60G is formed on the side of the distal end of the carriage arm 32, i.e., on the side facing the suspension 38.

A plurality of holes 62A, 62B, 62C are formed in the carriage arm 32 as shown in FIGS. 2 and 3 so as to suppress the pressure applied from the air stream below the carriage arm 32. Incidentally, even if the holes 62A, 62B, 62C are formed in the carriage arm 32, it is substantially possible for the carriage arm 32 to maintain a sufficient rigidity.

When the carriage arm 32 is swung toward the inner region of the magnetic disc 16, the air stream flowing from the central portion of the magnetic disc 16 toward the outer peripheral portion flows partly into the guide groove 60 through the guide section 60A formed in the carriage arm 32 and further flows along the guide section 60B toward the distal end of the carriage arm 32. It should be noted that the amount of the air stream flowing above and across the carriage arm 32 is decreased because the air stream partly flows stably along the guide section 60B. As a result, the shearing force applied to the carriage arm 32 is moderated so as to prevent the carriage arm 32 from being vibrated when the carriage arm 32 is swung toward the inner region of the magnetic disc 16. It should also be noted that the air stream flowing along the guide section 60B flows above the carriage arm 32 through the holes 62A, 62B, 62C. It follows that the force for lifting upward the carriage arm 32, which is generated by the air stream flowing along the guide section 60B, is weakened, and the carriage arm 32 is swung under this condition toward the inner region of the magnetic disc 16. As a result, it is possible to prevent without fail the vertical vibration of the carriage arm 32.

As shown in FIGS. 2 and 3, when the carriage arm 32 is swung so as to be positioned in the inner region of the magnetic disc 16, the air stream on the magnetic disc 16 is introduced similarly into the guide hole 60 through the introducing section 60A, and flows along the guide section 60B so as to flow toward the distal end of the carriage arm 32 through the outlet section 60G. It follows that the carriage arm 32 is swung under the state that the rigidity of the carriage arm 32 is substantially increased by the air stream flowing stably along the guide section 60B. As a result, the carriage arm 32 can be swung along the magnetic disc 16 without being vibrated by the air stream that is steadily generated between the carriage arm 32 and the magnetic disc 16. Also, the air stream flowing along the guide section 60B flows partly toward a region upward of the carriage arm 32 through the holes 62A, 62B, 62C. It follows that the force for lifting upward the carriage arm 32, which is generated by the air stream flowing along the guide section 60B, is weakened so as to permit the carriage arm 32 to be swung toward the inner region of the magnetic disc 16 under the weakened state of the lifting force. Since the lifting force in question is weakened, the carriage arm 32 is held substantially by the air stream layer that is stably formed between the carriage arm 32 and the magnetic disc 16 so as to prevent without fail the carriage arm 32 from being vibrated.

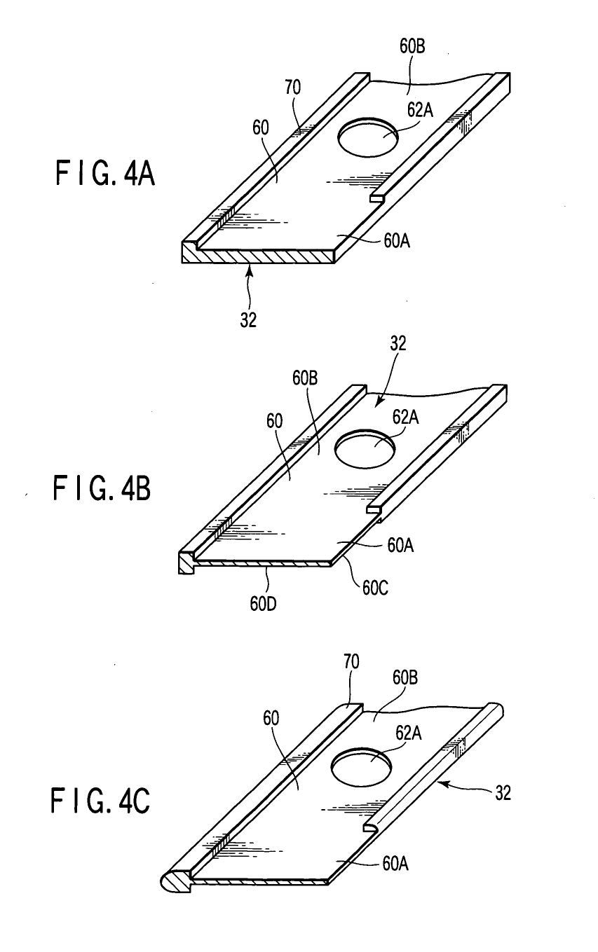

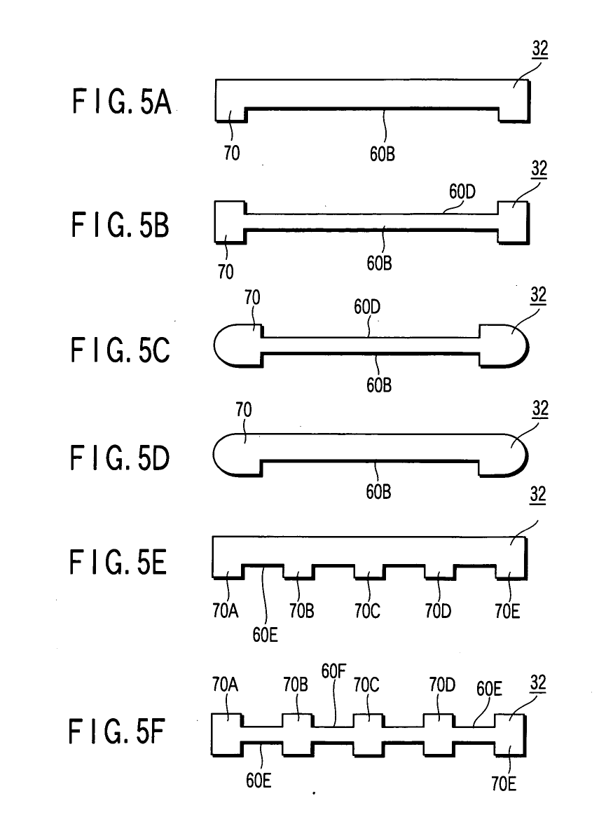

Each of FIGS. 4A to 4C shows the back surface of the carriage arm 32 together with the guide hole 60. For clearly setting forth the construction of the carriage arm 32, the drawing shows the state that the carriage arm 32 is inverted by 180° such that the upper surface in the drawing denotes the back surface of the carriage arm 32. FIG. 4A shows that the back side of the carriage arm 32 is selectively removed such that the right-left edges in the drawing of the carriage arm 32 are left unremoved so as to form guide walls 70 for rectifying the air stream on the both edge regions of the carriage arm 32. In the construction shown in FIG. 4A, the guide section 60B is defined between the guide walls 70 formed on the both edge regions of the carriage arm 32. FIG. 5A, which is a cross sectional view, shows more clearly the particular construction. Also, one of the two guide walls 70, i.e., the guide wall 70 on the right side in FIG. 4A, is partly removed so as to form the introducing section 60A. It is not absolutely necessary for the guide section 60B and the introducing section 60A to be formed on the back side of the carriage arm 32. It is also possible to form an introducing section 60C and a guide section 60D on the front side of the carriage arm 32 together with the introducing section 60A and the guide section 60B formed on the back side, as shown in FIGS. 4B and 5B. In other words, it is possible to form the introducing section and the guide section on each of the back side and the front side of the carriage arm 32. In the carriage arm 32 shown in FIGS. 4B and 5B, the air stream flowing in the longitudinal direction of the carriage arm 32 is formed on each of the front side and the back side of the carriage arm 32, and the carriage arm 32 can be swung along the magnetic disc 16 toward an inner region of the magnetic disc 16. The introducing section 60C and the guide section 60D can be formed on the front side of carriage arm 32 by selectively removing the front side of the carriage arm 32 such that the right-left edge portions in the drawing of the carriage arm 32 are left unremoved so as to form the guide walls 70 for rectifying the air stream on the both edge portions of the carriage arm 32.

It is possible for the guide wall 70 to be formed flat and to have a spindle-shaped outer surface (or curved outer surface) as shown in FIGS. 4C and 5C so as to decrease the resistance of the guide wall 70 to the air stream flowing in a direction substantially perpendicular to the longitudinal direction of the carriage arm 32. In this case, it is possible for the carriage arm 32 to be swung smoothly against the air stream flowing in a direction substantially perpendicular to the longitudinal direction of the carriage arm 32. Needless to say, it is possible for the guide section 60B to be formed on the back side alone of the carriage arm 32 in the case where the carriage arm 32 has two guide walls 70 each having a spindle-shaped outer surface as shown in FIG. 5D.

It is possible for the guide groove 60 to include a plurality of guide sections 60E defined between a plurality of guide walls 70A to 70E, as shown in FIG. 5E. These plural guide sections 60E are formed to guide the air stream such that the air stream flows in the longitudinal direction of the carriage arm 32. In the carriage arm 32 including these plural guide sections 60E, the air stream is introduced into the guide groove through the common introducing section 60A so as to be distributed into the guide sections 60E, and flows along the guide sections 60E in the longitudinal direction of the carriage arm 32. According to the construction shown in FIG. 5E, the carriage arm 32 is held by the stable air stream layer formed between the carriage arm 32 and the surface of the magnetic disc 16. It follows that it is possible to prevent without fail the carriage arm 32 from being vibrated. Naturally, it is possible for the plural guide sections 60E to be formed not only on the back surface but also on the front surface of the carriage arm 32, as shown in FIG. 5F.

In the embodiment described above, the guide groove 60 is defined by the guide walls 70 performing the air flow rectifying function. However, it is also possible for the guide groove to be defined by plate-like guide vanes that are mounted in a manner to produce a flow rectifying function for allowing the air stream to flow along the guide groove 60 defined between the guide vanes. In other words, in the embodiment described above, it is possible to employ a groove or guide vanes as long as it is possible to guide the air stream in the longitudinal direction of the carriage arm 32, and it suffices to mount these groove or guide vanes in the vicinity of the rotary shaft (bearing section) of the carriage arm 32 or in the vicinity of a region through which passes the edge (outer circumferential edge) of the magnetic disc during rotation of the magnetic disc. As a result, it is possible to diminish the shearing moment in the position where the largest shearing moment is applied to the carriage arm 32. Also, by controlling the flow of the air stream at the particular position, the force received by the carriage arm 32 from the air stream in changing the flowing direction of the air stream can be suppressed to the minimum level so as to make it possible to prevent the positioning accuracy of the magnetic head from being worsened.

As described above, the guide groove 60 is formed on that side of the carriage arm 32 which faces the magnetic disc 16 in the disc drive apparatus of the present invention. As a result, it is possible to guide optionally the air stream flowing through the clearance between the carriage arm 32 and the magnetic disc 16 so as to make it possible to suppress the turbulence of the air stream (air turbulence) around the carriage arm 32. Particularly, the air stream flowing across the carriage arm 32 can be suppressed by guiding the air stream to flow in the longitudinal direction of the carriage arm 32. It follows that the shearing moment around the bearing section 26 supporting the carriage arm 32 can be suppressed so as to improve the positioning accuracy of the magnetic head.

It should also be noted that the groove or guide vanes serving to suppress the vibration of the carriage arm can be formed integral with the carriage arm. It follows that the positioning accuracy of the magnetic head can be improved without increasing the number of parts so as to provide at a low cost a disc drive apparatus capable of achieving an improved head positioning accuracy. Also, since the vibration-suppressing member is formed integral with the carriage arm, the vibration suppressing effect can be similarly expected at any position of the carriage arm in writing-reading recording data.

According to the disc drive apparatus of the present invention, it is possible to suppress the vibration of the carriage arm that is caused by the shearing stress applied between the magnetic disc and the carriage arm so as to improve the positioning accuracy of the magnetic head.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A disc drive apparatus, comprising:
a casing;
a magnetic disc housed in the casing and including a disc surface region configured to record information;
a motor rotating the disc;
a magnetic head configured to record information in the disc surface region and reproduce the recorded information;
a suspension that supports the head;
a carriage arm supporting the suspension; and
a carriage mechanism having the carriage arm mounted thereto and serving to swing the head toward an inner region of the disc surface, the carriage arm includes a guide groove arranged to face the disc surface in the longitudinal direction of the carriage arm.

2. The disc drive apparatus according to claim 1, wherein the guide groove is curved.

3. The disc drive apparatus according to claim 1, wherein the guide groove is formed on each of the upper and lower surfaces of the carriage arm.

4. The disc drive apparatus according to claim 1, wherein the guide groove includes an introducing section and outlet section.

5. The disc drive apparatus according to claim 1, wherein a plurality of holes are formed in the carriage arm.

6. The disc drive apparatus according to claim 1, wherein the guide groove includes a plural of guide sections and a plural of guide walls in the longitudinal direction of the carriage arm.

7. The disc drive apparatus according to claim 1, wherein the edge of the carriage arm is formed in the round.

8. The disc drive apparatus according to claim 1, wherein the carriage arm includes an introducing part configured to introduce at least a part of the air stream flowing in a direction substantially perpendicular to the longitudinal direction of the carriage arm into a guide section of the guide groove.

9. The disc drive apparatus according to claim 1, wherein the carriage arm includes a groove or guide vanes defining the guide section.

10. The disc drive apparatus according to claim 1, wherein the carriage mechanism includes a rotary shaft supporting the carriage arm such that the carriage arm is swingable, and a guide part is formed in the vicinity of the rotary shaft of the carriage mechanism or in that region of the carriage arm which crosses the outer circumferential region of the magnetic disc in accordance with the swinging of the carriage arm.

11. The disc drive apparatus according to claim 1, wherein the carriage arm is formed to have a curved outer surface.

12. The disc drive apparatus according to claim 1, wherein the carriage arm includes another guide part formed on the side opposite to the side facing the disc surface for guiding the air stream generated on the disc surface such that the air stream is guided to flow in the longitudinal direction of the carriage arm.

13. A disc drive apparatus, comprising:
a casing;
a magnetic disc housed in the casing and including a disc surface region configured to record information;
a motor rotating the disc;
a magnetic head configured to record information in the disc surface region and reproduce the recorded information;
a suspension supporting the head;
a carriage arm supporting the suspension; and
a carriage mechanism having the carriage arm mounted thereto and serving to swing the head toward an inner region of the disc surface, the carriage arm having a surface region facing the disc surface and a guide wall formed on the surface, the guide wall partially removed at the side of the rotary shaft and the side of supporting the suspension.
